(19) United States
(12) Patent Application Publication
(10) Pub. No.: US 2008/0019130 A1
(43) Pub. Date: Jan. 24, 2008

(54) Arrangement of Light-Emitting Diodes Of LED Lamp

(76) Inventor: Pei-Choa Wang, Gueishan Township (TW)

Correspondence Address: HDSL, 4331 STEVENS BATTLE LANE, FAIRFAX, VA, 22033, US

(21) Appl. No.: 11/459,447

(22) Filed: Jul. 24, 2006

(51) Int. Cl. F21V 21/00

(52) U.S. Cl. 362/249

(57) ABSTRACT

An improved arrangement of light-emitting diodes of a LED lamp includes a circuit board and a plurality of light-emitting diodes. The surface of the circuit board is provided with a layer of conductive circuit, so that the light-emitting diodes can be arranged on the circuit board and electrically connected to the conductive circuit. On the surface of the circuit board provided with the conductive circuit, an imaginary circle is defined. Further, the light-emitting diodes are distributed on the circuit board along the imaginary circle to form a circular arrangement.

### BACKGROUND OF THE INVENTION

1. Field of the Invention

The present invention relates to an improved arrangement of light-emitting diodes of a LED lamp, and in particular to an improved arrangement of light-emitting diodes of a LED lamp, in which the light-emitting diodes are arranged in a circular form.

2. Description of Prior Art

Since light-emitting diodes (LED) are high-intensity, energy-saved and long-life, they are widely used in the illumination of electronic devices or lamps. Further, in order to increase the illuminating range and intensity thereof, a plurality of light-emitting diodes are usually combined to form a LED lamp set, thereby to form an illuminating surface by those light-emitting diodes.

The illuminating surface of a common lamp is usually formed into a circular shape. However, the light-emitting diodes provided on the LED lamp set are currently arranged on its circuit board in an array, which is not suitable for the design of the second-ordered optical lens of the circular illuminating surface of the common lamp. Further, the layout on the circuit is also inconvenient.

In view of the above, the inventor proposes the present invention to overcome the above problems based on his expert experiences and deliberate researches.

### SUMMARY OF THE INVENTION

The present invention is to provide an improved arrangement of light-emitting diodes of a LED lamp, which cooperates with the circular illuminating surface of the common lamp to allow each light-emitting diode to be arranged in a circular form. In this way, it is not only helpful to design the second-ordered optical lens of the LED lamp, but also to produce a conductive circuit by means of series connection, parallel connection or the combination of the two. Thus, the conductive circuit will not be affected by the arrangement of each light-emitting diode to cause the difficulty in layout and design.

The present invention provides an improved arrangement of light-emitting diodes of a LED lamp, which comprises a circuit board and a plurality of light-emitting diodes. The surface of the circuit board is provided with a layer of conductive circuit, so that the light-emitting diodes can be arranged on the circuit board and electrically connected to the conductive circuit. On the surface of the circuit board provided with the conductive circuit, an imaginary circle is defined. Further, the light-emitting diodes are distributed on the circuit board along the imaginary circle to form a circular arrangement. With the circular arrangement of each light-emitting diode, the above objects can be achieved.

### BRIEF DESCRIPTION OF THE DRAWINGS

FIG. 1 is a perspective view of the first embodiment of the present invention;

FIG. 2 is a top plan view of the first embodiment of the present invention;

FIG. 3 is a cross-sectional view taken along the line 3-3 in FIG. 2;

FIG. 4 is a top plan view of the second embodiment of the present invention;

FIG. 5 is a top plan view of the third embodiment of the present invention; and

FIG. 6 is a cross-sectional view taken along the line 6-6 in FIG. 5.

### DETAILED DESCRIPTION OF THE INVENTION

In order to make the Examiner better understand the characteristics and the technical contents of the present invention, the following detailed description will be made with reference to the accompanying drawings. However, it should be understood that the drawings are illustrative but not used to limit the scope of the present invention.

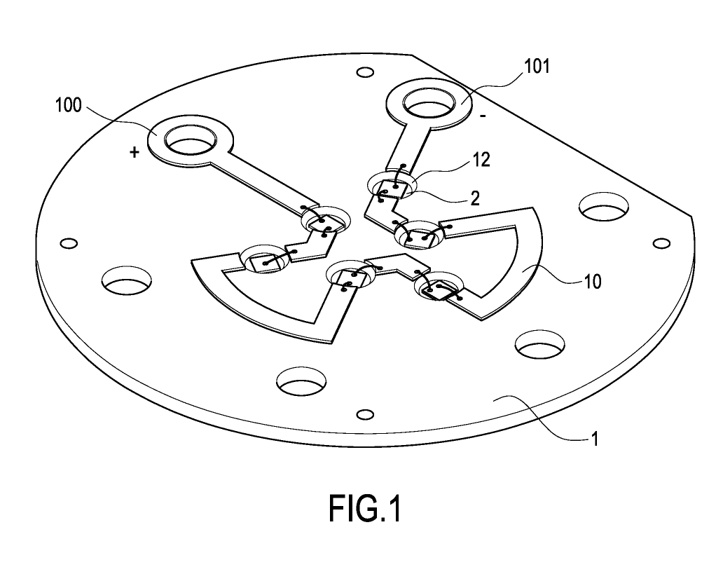

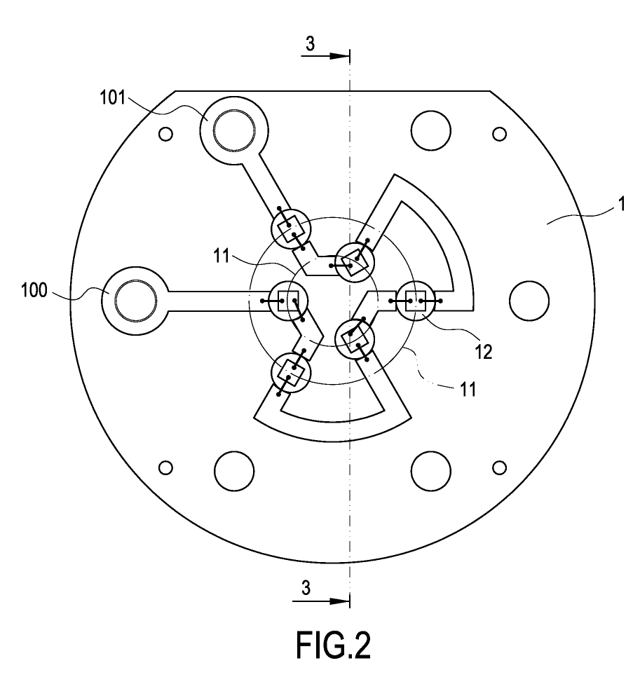

With reference to FIG. 1 and FIG. 2, which are a perspective view and a top plane view of the first embodiment of the present invention, respectively. The present invention provides an improved arrangement of light-emitting diodes of a LED lamp, which comprises a circuit board 1 and a plurality of light-emitting diodes (LED) 2 provided on the circuit board 1.

The circuit board 1 is an insulating plate. A layer of conductive circuit 10 formed of metallic conductive materials such as copper foil is plated on the surface of the circuit board, so that each light-emitting diode 2 arranged thereon can be electrically connected in series connection or parallel connection. The external appearance and the size of the circuit board 1 can be designed according to the lamps to be used. Further, the number of the light-emitting diodes 2 can be determined according to the conditions in practice.

The characteristic of the present invention lies in that the arrangement of the light-emitting diodes 2 on the circuit board 1 is formed into a circular shape or several concentric circles. Further, after the light-emitting diodes 2 are electrically connected via the above conductive circuit 10, the positive and negative contacts 100, 101 are located at the outer periphery of the light-emitting diodes 2. Such arrangement is very suitable for the design of the second-ordered optical lens of the circular illuminating surface of a common lamp. Further, it is easier to produce a series-connection or parallel-connection circuit.

The circular arrangement can be defined as follows. First, on the surface of the circuit board 1 provided with the conductive circuit 10, at least one imaginary circle 11 is defined (FIG. 2). Then, the light-emitting diodes 2 are distributed on the imaginary circle 11. Further, when the arrangement is formed of several concentric circles, a plurality of imaginary circles 11 can be defined to arrange in a concentric way. Then, the light-emitting diodes 2 are distributed on each imaginary circle 11. The light-emitting diodes 2 on the inner and outer imaginary circles 11 can be further staggered.

With reference to FIGS. 1 to 3 again, in the first embodiment of the present invention, the light-emitting diodes 2 are electrically connected to the conductive circuit 10 in series connection. At the same time, at the position in which each light-emitting diode 2 is arranged on the circuit board 1, a recess 12 is provided for receiving each light-emitting diode 2, thereby to perform the packaging procedure of each light-emitting diode 2. A first-ordered lens 20 is formed above each recess 12. After each first-ordered lens 20 is formed on each light-emitting diode 2, the light-emitting diodes 2 can be subjected to a so-called second-ordered optical lens treatment, thereby to complete the LED lamp set.

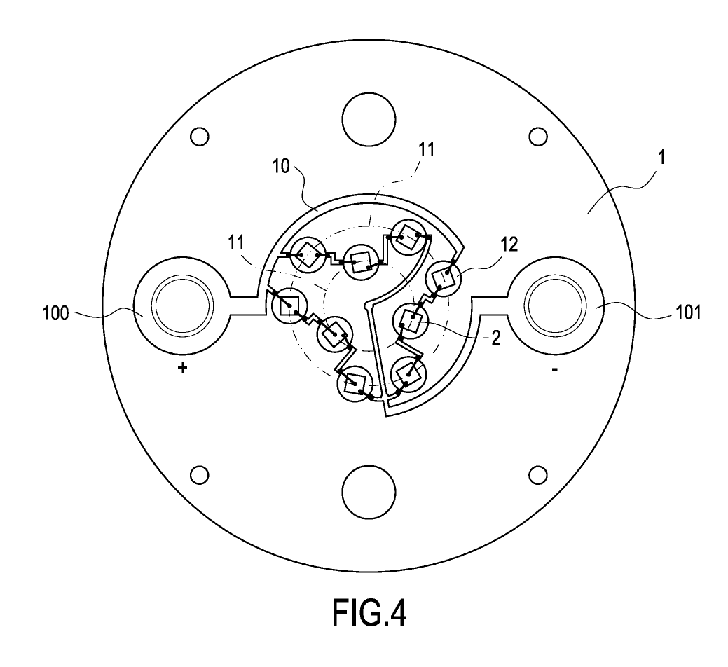

In addition, as shown in FIG. 4, in the second embodiment of the present invention, every three adjacent light-emitting diodes 2 are electrically connected in series on the conductive circuit 10, and the thus-connected light-emitting diodes 2 are electrically connected in parallel connection. Since the light-emitting diodes are arranged in a circular shape and the light-emitting diodes 2 in the inner and outer imaginary circles 11 are staggered, each light-emitting diode 2 has a sufficient space for the design and layout of the conductive circuit 10. In other words, in the present invention, the circular arrangement of each light-emitting diode 2 helps to produce the conductive circuit 10 in series connection, parallel connection or the combination of the two. Also, the conductive circuit 10 will not be affected by the arrangement of each light-emitting diode to cause the difficulty in layout and design.

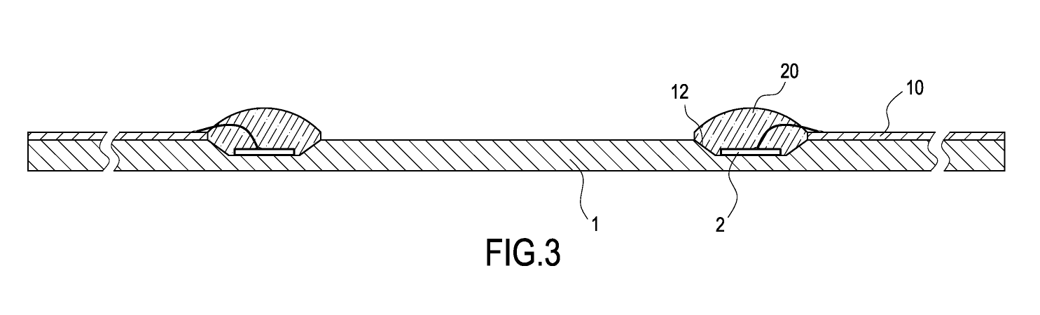

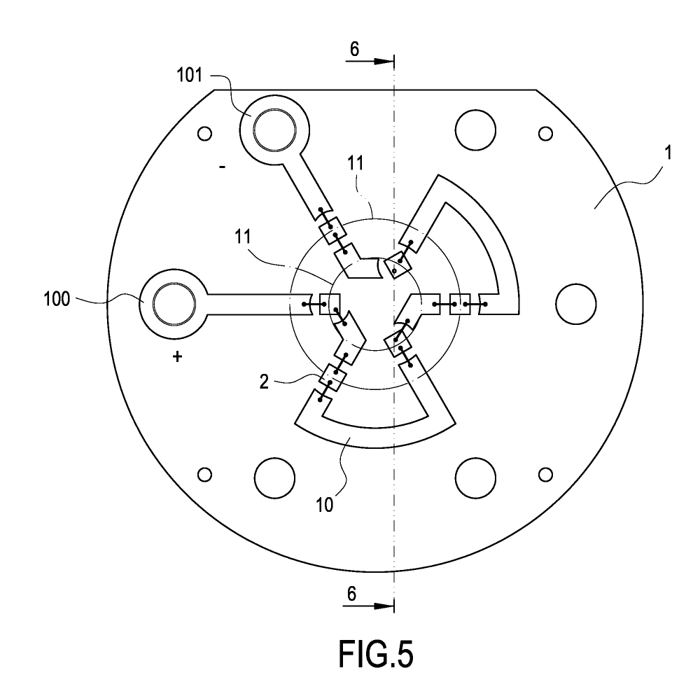

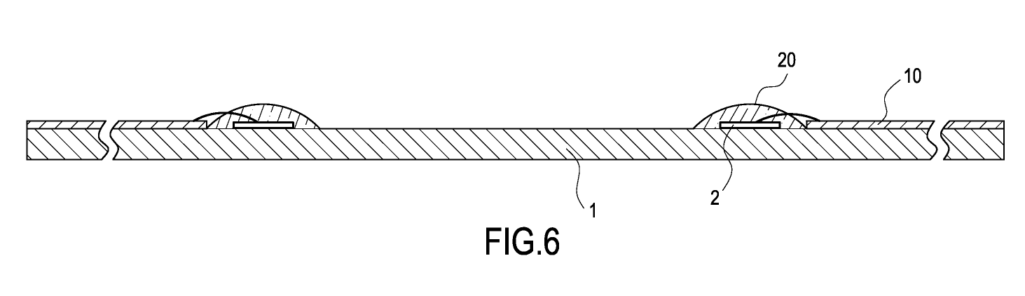

Further, as shown in FIG. 5 and FIG. 6, at the position in which each light-emitting diode 2 is arranged on the circuit board 1, it is not necessary to provide the recess 12 for receiving each light-emitting diode 2 (FIG. 3). That means each light-emitting diode 2 is directly arranged on the surface of the circuit board 1, so that the packaging procedure of the light-emitting diodes 2 can be similarly performed.

According to the above, the present invention indeed achieves the desired effects and overcomes the drawbacks of prior art. Therefore, the present invention involves the novelty and inventive steps, and conforms to the requirements for an invention patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. An arrangement of light-emitting diodes of a LED lamp, comprising:
a circuit board provided on one surface thereof with a layer of conductive circuit; and
a plurality of light-emitting diodes respectively provided on the circuit board to be electrically connected to the conductive circuit,
wherein on the surface of the circuit board provided with the conductive circuit, an imaginary circle is defined, and the light-emitting diodes are distributed on the circuit board along the imaginary circle to form a circular arrangement.

2. The arrangement of light-emitting diodes of a LED lamp according to claim 1, wherein positive and negative contacts of the conductive circuit are located at an outer periphery of the light-emitting diodes.

3. The arrangement of light-emitting diodes of a LED lamp according to claim 1, wherein a plurality of imaginary circles are further defined, each imaginary circle is arranged in a concentric way, and the light-emitting diodes are distributed on each imaginary circle.

4. The arrangement of light-emitting diodes of a LED lamp according to claim 3, wherein each light-emitting diode on inner and outer imaginary circles is staggered.

5. The arrangement of light-emitting diodes of a LED lamp according to claim 1, wherein a position in which each light-emitting diode is arranged on the circuit board is provided with a recess for receiving each light-emitting diode.

6. The arrangement of light-emitting diodes of a LED lamp according to claim 1, wherein each light-emitting diode is formed with a first-ordered lens thereon.
